(19) United States
(12) Patent Application Publication
(10) Pub. No.: US 2014/0157921 A1
(43) Pub. Date: Jun. 12, 2014

(54) LINEAR ACTUATOR

(71) Applicant: J-STAR MOTOR INDUSTRIAL CO., LTD, Taipei City (TW)

(72) Inventor: Kuo-Cheng WU, Pitou Township (TW)

(73) Assignee: J-STAR MOTOR INDUSTRIAL CO., LTD., Taipei City (TW)

(21) Appl. No.: 13/778,512

(22) Filed: Feb. 27, 2013

(30) Foreign Application Priority Data
Dec. 10, 2012 (TW) 101223909

(51) Int. Cl. F16H 25/20

(52) U.S. Cl. CPC F16H 25/20
USPC 74/89.32

(57) ABSTRACT

A linear actuator includes a motor, a transmission mechanism including a housing defining an accommodation chamber, a screw rod inserted with its one end into the accommodation chamber, a worm gear threaded onto the screw rod and coupled to the motor, two axle bearings mounted at the worm gear at two opposite sides and a top cover covering the housing, and a linking mechanism fixedly mounted in the housing and including a tubular member defining a longitudinal straight passage for receiving the other end of the screw rod and two sliding slots at two opposite sides and a screw nut formed of a linking member that is threaded onto the screw rod and two mating connection members respectively slidably mounted in the sliding slots and connected to the linking member. Thus, the supported worktable can be moved along the full length of the screw rod.

### BACKGROUND OF THE INVENTION

1. Field of the Invention

The present invention relates to linear actuator technology and more particularly, to a full-stroke displacement type linear actuator.

2. Description of the Related Art

With great advancement of modern science and technology, automated manufacturing technology is relatively steadily growing, while the linear actuator is one of the indispensable components of automated manufacturing equipment. Many different linear actuators are known. FIG. 1 illustrates a linear actuator according to the prior art. As illustrated, this design of linear actuator 1 comprises a motor (not shown), a housing 2, a transmission mechanism 3 and a linking mechanism 4. The rotary driving force of the motor is transferred to the transmission mechanism 3 to rotate a screw rod 5 of the transmission mechanism 3. The screw rod 5 is threaded into a screw nut 6 at a rear end of the linking mechanism 4. The housing 2 prohibits the linking mechanism 4 against lateral displacement. Thus, the linking mechanism 4 can be driven to move linearly along the central axis of the screw rod 5, forcing a front locating head 7 to move a worktable.

However, the linking mechanism 4 of the aforesaid linear actuator 1 must be moved in the housing 2, i.e., the movable distance of the linking mechanism 4 is within the range of: the internal length of the housing 2 less the length of the screw nut 6. In consequence, the working stroke of the linear actuator 1 is restricted by the screw nut 6, causing the effectiveness of the linear actuator 1 to be greatly reduced. Further, this drawback makes the dimension of the linear actuator cannot be significantly reduced, narrowing its range of applications. Further, the front locating head 7 is fixedly mounted at the front end of the linking mechanism 4 for connection with the worktable by means of a locating hole 8 thereon, enabling the worktable to be moved. However, in this design, the locating hole 8 must be kept above the elevation of the outer tube 9 of the linking mechanism 4. Thus, the lifting range of the linear actuator is limited to the inside of the outer tube 9. In other words, increasing the lifting range of the linear actuator 1 must extend the length of the outer tube 9. In consequence, the elevation of the worktable will be many restricted. Further, if the length of the outer tube 9 largely protrudes over the housing 2, the worktable can easily be vibrated. Further, in the aforesaid linear actuator, the outer tube 9 is secured between the screw nut 6 and the front locating head 7 by means of screw connection. Thus, the outer tube 9 may fall from the linear actuator if the worktable is overloaded or frequently vibrated, undoubtedly increasing the danger of work.

Taiwan Utility No. M369950 discloses a push bar structure for linear actuator. According to this design, an outer tube is equipped with a screw nut for long distance displacement to increase the range of applications. During installation of the push bar structure, the screw nut is attached to the outer tube that is made out of two aluminum extruded profiles, and then the screw rod is threaded into the screw nut. Alternatively, the screw nut can be threaded onto the screw rod, and then the two aluminum extruded profiles of the outer tube are inserted through the screw nut, and then the assembly is affixed to the housing. The installation of the push bar structure in either of the aforesaid two alternate ways is complicated, wasting too much time. The reason is that mounting the screw nut at the outer tube requires much time in alignment. Further, in order to affix the two aluminum extruded profiles to the housing, a machining process must be employed to stamp or drill the aluminum extruded profiles. In consequence, the installation time and labor and the manufacturing cost of the linear actuator are significantly increased.

### SUMMARY OF THE INVENTION

The present invention has been accomplished under the circumstances in view. It is the main object of the present invention to provide a linear actuator, which enables the worktable to be lifted along the full length of the screw rod of the linear actuator, making it ideal for a broad range of applications.

To achieve the primary object of the present invention, a linear actuator comprises a motor, a transmission mechanism coupled to and rotatable by the motor, and a linking mechanism. The transmission mechanism comprises a housing, a screw rod, a worm gear, two axle bearings and a top cover. The housing defines therein an accommodation chamber. The screw rod has its one end inserted into the housing and positioned in the accommodation chamber. The worm gearing is threaded onto the screw rod, and coupled to the motor. The two axle bearings are respectively mounted at two opposite sides of the worm gear. The top cover is capped on the housing to hold the screw rod, the worm gear and the axle bearings inside the housing. The linking mechanism is fixedly mounted in the housing of the transmission mechanism, comprising a tubular member and a screw nut. The tubular member comprises a longitudinal straight passage defined therein for receiving an opposite end of the screw rod, and two sliding slots longitudinally disposed at two opposite lateral sides. The screw nut comprises a linking member and two mating connection members. The linking member is threaded onto the screw rod. The mating connection members are respectively slidably mounted in the longitudinal sliding slots and connected to the linking member for enabling the screw nut to be moved axially back and forth along the sliding slots of the tubular member.

Thus, the dimension of the whole structure of the linear actuator is greatly reduced and the length of the screw rod and the length of the tubular member are used for full-stroke application, and, the worktable can be lifted along the full length of the screw rod, making it ideal for a broad range of applications. Further, the whole structure of the linear actuator is compact, facilitating installation and saving material cost.

It is another object of the present invention to provide a linear actuator, which avoids falling of the screw nut of the linear actuator due to overload or vibration of the supported worktable.

To achieve the other object of the present invention, the linking member of the screw nut comprises an engagement section; each the mating connection member of the screw nut comprises an engagement portion detachably engageable with the engagement section of the linking member for enabling the mating connection members to be detachably fastened to the linking member.

By means of using the engagement between the engagement section of the screw nut and the engagement portions of the mating connection members instead of the prior art design to fasten the outer tube by a screw joint, the invention effectively eliminates the problem of the prior art that the outer tube can fall easily due to overload or vibration of the supported worktable.

It is still another object of the present invention to provide a linear actuator, which saves component fabrication and material costs and simplifies the installation procedure, thereby greatly reducing the cost of the linear actuator.

To achieve this object of the present invention, the invention provides a linking mechanism for the linear actuator. The linking mechanism comprises a tubular member and a screw nut. The tubular member comprises a longitudinal straight passage defined therein for receiving one end of a screw rod of the linear actuator, and two sliding slots longitudinally disposed at two opposite lateral sides. The screw nut comprises a linking member and two mating connection members. The linking member is threaded onto the screw rod. The mating connection members are respectively slidably mounted in the longitudinal sliding slots and connected to the linking member for enabling the screw nut to be moved axially back and forth along the sliding slots of the tubular member.

Further, the tubular member is a one-piece extruded aluminum member. This one-piece aluminum extrusion type tubular member saves much material and processing cost. During installation of the linking mechanism, it simply needs to thread the linking member onto the screw rod and then to attach the tubular member around the screw rod. This installation procedure is simple, saving much installation time and labor.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is sectional view of a linear actuator according to the prior art.

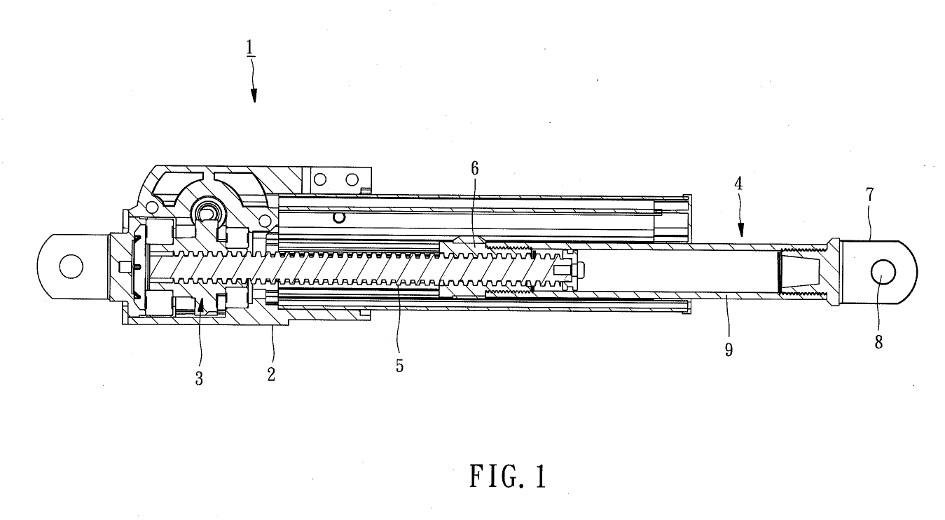

FIG. 2 is an elevational view of a linear actuator in accordance with the present invention.

FIG. 3 is an exploded view of the present invention, illustrating the relative positions among the component parts of the linear actuator.

FIG. 4 is a schematic sectional view of the present invention, illustrating the relationship among the component parts during operation of the linear actuator.

### DETAILED DESCRIPTION OF THE INVENTION

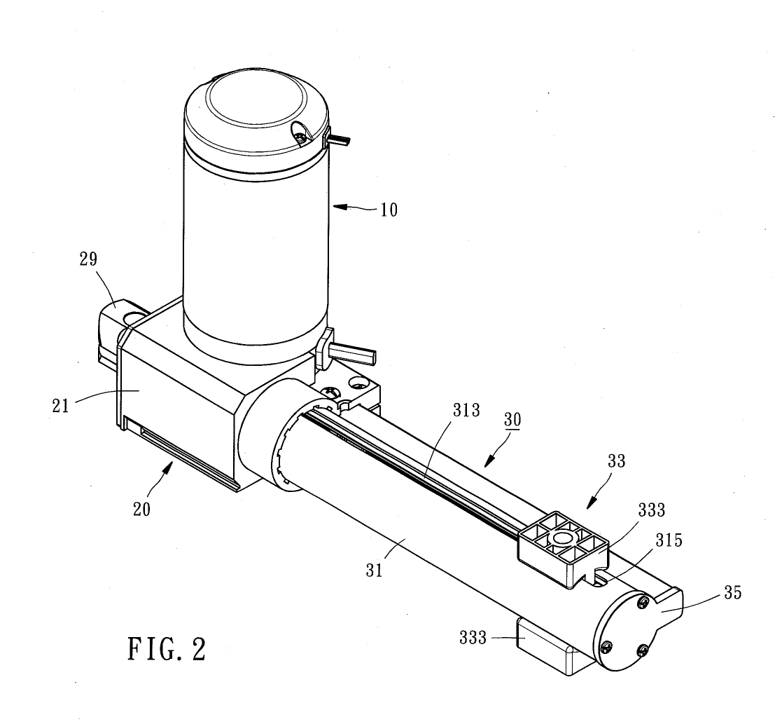

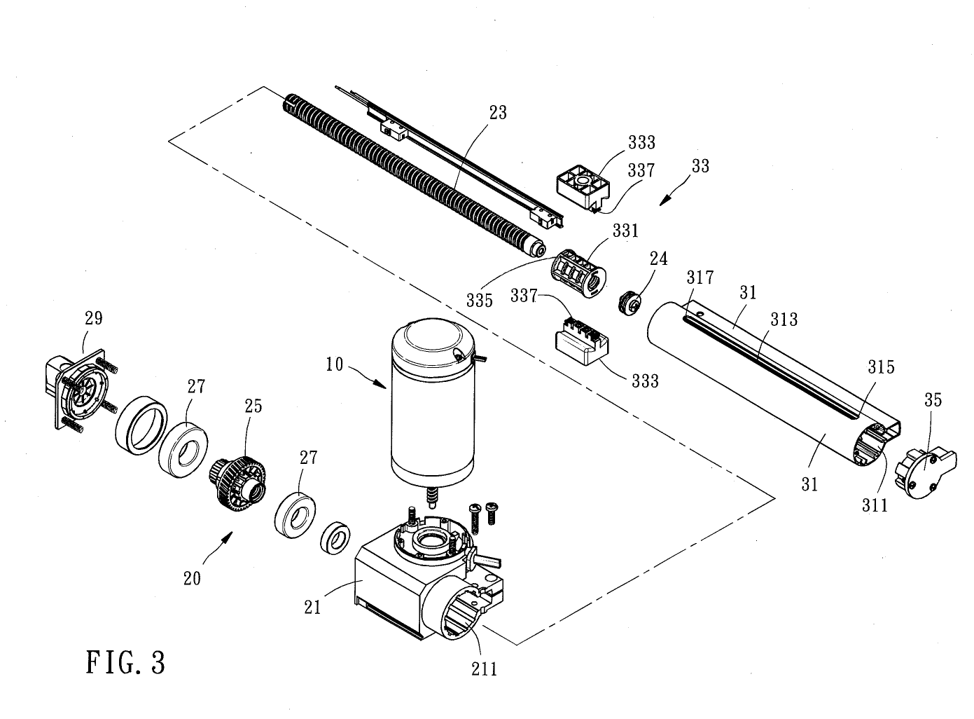

Referring to FIGS. 2-4, a linear actuator in accordance with the present invention is shown. The linear actuator comprises a motor 10, a transmission mechanism 20, and a linking mechanism 30.

The transmission mechanism 20 is coupled to the motor 10 and rotatable by the motor 10, comprising a housing 21, a screw rod 23, a stop member 24, a worm gear 25, two axle bearings 27, and a top cover 29. The housing 21 defines therein an accommodation chamber 211. The screw rod 23 has its one end inserted into the housing 21 and positioning in the accommodation chamber 211. The stop member 24 is fixedly mounted at the other end of the screw rod 23 remote from the housing 21. The worm gear 25 is internally threaded onto the screw rod 23 and externally coupled to the motor 10. The two axle bearings 27 are respectively mounted at two opposite sides of the worm gear 25. The top cover 29 is capped on the housing 21, allowing the screw rod 23, the worm gear 25 and the axle bearings 27 to be accommodated in the housing 21.

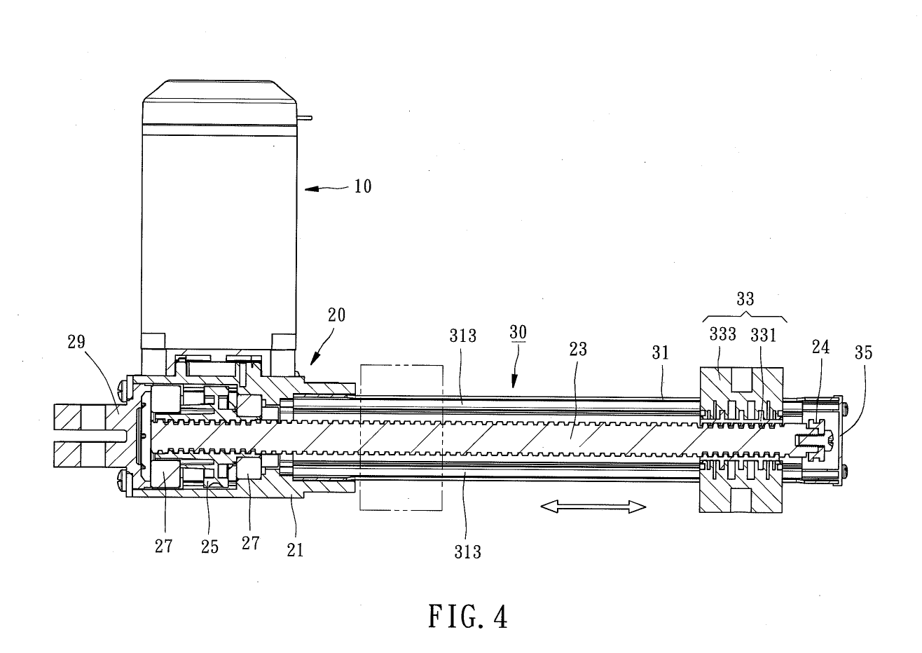

The linking mechanism 30 is fixedly mounted at the housing 21 of the transmission mechanism 20, comprising a tubular member 31, a screw nut 33 and a front cover 35. The tubular member 31 is extruded from one-piece aluminum, defining therein a longitudinal straight passage 311 and two longitudinal sliding slots 313 at two opposite lateral sides relative to the longitudinal straight passage 311. The longitudinal straight passage 311 is adapted for the insertion of the other end of the screw rod 23. Each longitudinal sliding slot 313 defines opposing first stop end 315 and second stop end 317. The screw nut 33 comprises a linking member 331 and two mating connection members 333. The linking member 331 is threaded onto the screw rod 23. The mating connection members 333 are respectively slidably coupled to the sliding slots 313 of the tubular member 31 and connected to two opposite sides of the linking member 331 to guide axial sliding movement of the screw nut 33 along the sliding slots 313 between the first stop ends 315 and second stop ends 317 of the sliding slots 313. The linking member 331 of the screw nut 33 can be firmly secured to the screw rod 23 in position by the stop member 24 of the transmission mechanism 20. Further, the front cover 35 is capped on a top end of the tubular member 31, keeping the linear actuator in an enclosed condition to prevent falling of external objects to the inside of the linear actuator to affect the lifting function of the linear actuator. Further, as shown in FIG. 4, when lifting the worktable, the screw nut 33 will be moved axially along the screw rod 23 to the top end thereof and stopped at the first stop ends 315 of the longitudinal sliding slots 313 of the tubular member 31; on the contrary, when lowering the worktable, the screw nut 33 will be moved axially along the screw rod 23 to the bottom end thereof and stopped at the second stop ends 317 of the longitudinal sliding slots 313 of the tubular member 31. Thus, the linear actuator of the present invention allows for full-stroke displacement.

To facilitate installation and to enhance structural stability, the linking member 331 of the screw nut 33 is configured to provide an engagement section 335, and each mating connection member 333 of the screw nut 33 is configured to provide an engagement portion 337 detachably engageable with the engagement section 335 of the linking member 331, and therefore, the mating connection members 333 can be detachably fastened to the linking member 331. The engagement arrangement between the engagement section 335 of the screw nut 3 and the engagement portions 337 of the mating connection members 333 is unlike the screw joint fixation arrangement of the outer tube of the prior art design, eliminating the problem of the prior art that the outer tube can fall easily due to overload or vibration of the supported worktable.

In conclusion, the linear actuator of the present invention has the advantages and features as follows:

1. The dimension of the whole structure of the linear actuator is greatly reduced and the length of the screw rod 23 and the length of the tubular member 31 are used for full-stroke application, and thus, the worktable can be lifted along the full length of the screw rod 23, making it ideal for a broad range of applications.

2. An engagement section 33 and an engagement portion 337 are respectively provided at the linking member 331 of the screw nut 33 and each mating connection member 33 for engagement, and this engagement arrangement between the engagement section 335 of the screw nut 3 and the engagement portions 337 of the mating connection members 333 effectively eliminates the problem of the prior art that the outer tube can fall easily due to overload or vibration of the supported worktable.

3. The whole structure of the linear actuator is compact. By means of threading the linking member 331 onto the screw rod 23 and then attaching the one-piece aluminum extrusion type tubular member 31 around the screw rod 23, the installation is done. Thus, the installation of the present invention is simple, and the material cost is greatly reduced.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A linear actuator, comprising:
a motor;
a transmission mechanism coupled to and rotatable by said motor, said transmission mechanism comprising a housing, a screw rod, a worm gear, two axle bearings and a top cover, said housing defining therein an accommodation chamber, said screw rod having one end thereof inserted into said housing and positioned in said accommodation chamber, said worm gearing being threaded onto said screw rod and coupled to said motor, said two axle bearings being respectively mounted at two opposite sides of said worm gear, said top cover being capped on said housing to hold said screw rod, said worm gear and said axle bearings inside said housing; and
a linking mechanism fixedly mounted in said housing of said transmission mechanism, said linking mechanism comprising a tubular member and a screw nut, said tubular member comprising a longitudinal straight passage defined therein for receiving an opposite end of said screw rod and two sliding slots longitudinally disposed at two opposite lateral sides, said screw nut comprising a linking member and two mating connection members, said linking member being threaded onto said screw rod, said mating connection members being respectively slidably mounted in said longitudinal sliding slots and connected to said linking member for enabling said screw nut to be moved axially back and forth along said sliding slots of said tubular member.

2. The linear actuator as claimed in claim 1, wherein said linking member of said screw nut comprises an engagement section; each said mating connection member of said screw nut comprises an engagement portion detachably engageable with said engagement section of said linking member for enabling said mating connection members to be detachably fastened to said linking member.

3. The linear actuator as claimed in claim 2, wherein each said longitudinal sliding slot of said tubular member defines opposing first stop end and second stop end adapted to limit sliding movement of said screw nut between the first stop ends and second stop ends of said longitudinal sliding slots of said tubular member.

4. The linear actuator as claimed in claim 1, wherein said transmission mechanism further comprises a stop member mounted at an opposite end of said screw rod remote from said top cover.

5. The linear actuator as claimed in claim 1, wherein said transmission mechanism further comprises a front cover capped on a top end of said tubular member to keep said linking mechanism in an enclosed status.
